(19) United States
(12) Patent Application Publication
(10) Pub. No.: US 2009/0015200 A1
(43) Pub. Date: Jan. 15, 2009

(54) METHOD AND ARRANGEMENT FOR MODIFYING THE STATE OF CHARGE (SOC) AND STATE OF HEALTH (SOH) OF A BATTERY

(76) Inventor: Martin Wieger, Wulkaprodersdorf (AT)

Correspondence Address: GREENBLUM & BERNSTEIN, P.L.C., 1950 ROLAND CLARKE PLACE, RESTON, VA, 20191, US

(21) Appl. No.: 12/162,954

(22) PCT Filed: Feb. 1, 2007
(86) PCT No.: PCT/AT2007/000047

§ 371 Date: Sep. 8, 2008

(30) Foreign Application Priority Data
Feb. 2, 2006 (AT) 163/2006
Aug. 7, 2006 (AT) 1314/2006

(51) Int. Cl. H02J 7/00

(52) U.S. Cl. 320/130

(57) ABSTRACT

A high state of charge results in reduced ageing and less wear of and to a rechargeable battery. Furthermore, acid stratification occurs in rechargeable batteries, primarily as a result of the influence of the force of gravity on the electrolyte, leading to a significant reduction in the performance of the rechargeable battery. The subject matter of the invention describes a method and an arrangement for varying the state of charge and state of health of rechargeable batteries, in which a separate electric current (i) is applied individually to at least one cell (Z) in the multicell rechargeable battery (1), this current (i) being superimposed on a working current (i_{A}), and with this current (i) acting on this at least one cell (Z) in order to charge or discharge this cell (Z).

The invention relates to a method for varying the state of charge and state of health (SOC, SOH) of multicell rechargeable batteries, and to an arrangement for carrying out the method.

A state of charge improvement primarily results in an increase in the energy reserves in the rechargeable battery. However, a secondary effect is also to reduce the ageing and the wear of and to the rechargeable battery the higher the state of charge is or the higher the state of charge is kept. This is because, as is known, a low state of charge leads to sulphating, which is difficult to reverse, and sulphated areas of the rechargeable battery are subject to more wear. On the one hand, a better state of health of a rechargeable battery can likewise be regarded as a secondary effect of an improvement to the state of charge. On the other hand, however, dissipation of so-called acid stratification also leads to an improvement in the state of health.

The electrolytes used in rechargeable batteries are frequently dilute acids, for example sulphuric acid. Electrolyte or acid stratification, primarily aligned horizontally, is primarily generated in rechargeable batteries, such as lead-acid rechargeable batteries, by the influence of the force of gravity on the electrolytes. Fundamentally, such stratification always occurs and even new batteries from the factory exhibit acid stratification after completion of production. In principle, even rechargeable batteries using other technologies for binding the electrolyte (for example gel or AGM (absorbent glass mat)) as well as battery embodiments in different mechanical forms of the batteries or battery cells, are also affected by this, even if only to a lesser extent.

Acid stratification is exacerbated subsequently during use in the field of application of the battery, in particular as a result of discharge processes without subsequent complete recharging of the battery. The occurrence of acid stratification leads primarily to a significant reduction in the performance of the rechargeable battery. Secondarily, it leads to inhomogeneous wearing away and ageing of the plates of a battery, caused by the higher acid density in the lower area and the reduced acid density in the upper area of the individual cells of the battery. Consequential damage, for example corrosion, sludge formation and sulphating, as well as more rapid ageing of the battery associated with these phenomena, furthermore result from the acid in batteries being stratified.

Acid stratification occurs increasingly in rechargeable batteries, such as lead-acid rechargeable batteries, primarily when used in motor vehicles (starter batteries, local power supply system batteries) and in batteries that are used in stationary installations (UPS installations, solar installations) for several reasons, but in particular as a result of increasing
cyclic loads,
inadequate recharging operations, and
fixed mechanical installation of the plates.

A charging process can be designated as “inadequate recharging” when, either as a consequence of an inadequate charging voltage, an excessively short charging time or inadequate mobility of the ions (for example caused by low temperatures), the discharge product that is formed (for example lead sulphate when dilute sulphuric acid is used as the electrolyte) is not completely converted back again, or else in circumstances when the charging process is not adequate to thoroughly mix the electrolyte, and therefore overcome the acid stratification, by means of the chemical processes that occur (in particular gassing). The process of thorough mixing of the acid by gas bubble formation in the cells of a rechargeable battery works in a known manner such that the electrolyte is (thoroughly mixed) moved by the upward movement of the individual gas bubbles. Because of the concentration of the gas bubbles in the upper area of the cell, those parts of the electrolyte which are located at a higher level are moved first of all. Those areas of the cell which are located lower down are thoroughly mixed as well only when the gassing process continues over a relatively long period of time.

Known methods to dissipate acid stratification are based either on conventional charging of the battery or on a separately generated method to achieve movement (circulation) of the electrolyte.

The known method of conventional charging is based on more or less large cell areas being charged at times or continuously with voltages above the respective gassing limit of the battery technology being used. One such method is disclosed, for example, in DE 103 54 055 A1. The reaction products (primarily gas bubbles) which are formed from this lead to the formation of flow profiles which in the end lead to dissipation of the stratification of the electrolyte. Charging methods such as these (direct current, alternating current and mixed-current charging methods) have been known for a long time in various forms from the prior art. Particularly when used in motor vehicles, or else in stationary installations, one problem that arises, however, is that complete charging (including dissipation of the stratification) is not possible because of a predetermined charging voltage limit. Single-cell charging methods, such as those in the case of lithium ion rechargeable batteries, can likewise be regarded as being known, and are used to monitor and to limit the charging voltage, in order to avoid overvoltages (explosion risk).

In addition, circuits are also known for current and voltage splitting for batteries which are connected in series and/or in parallel, so-called “equalizers”, for example from U.S. Pat. No. 6,801,014 B. Equalizers such as these just balance the charging current by splitting the charging current or the charging voltage as uniformly as possible between all the batteries. However, it is undesirable for equalizer circuits to vary the state of charge of individually defined cells, or individual batteries in a battery assembly, since the aim is in fact for equalization over all the cells or batteries.

The following methods are known as separately generated methods to form a flow profile for dissipation of electrolyte stratification:
use of auxiliary electrodes

The use of additional electrodes (auxiliary electrodes) makes it possible to form gas bubbles in addition to the electrode reaction that generally takes place in the rechargeable battery, for example as described in US 20030148170 A1 or JP 62-139248 A2. The disadvantage of this method is that an additional electrode must be inserted in the individual cells of the rechargeable battery and must either be made inert in terms of interaction with the electrochemical processes that take place in the rechargeable battery, or must be designed such that there is no (negative) influence on the electrochemical processes.
Blowing in gases

Gases (primarily ambient air) are blown into the cells through appropriate openings and gas ducts (tubes). The gas outlet locations are in this case preferably located in the lower area of the cells, as described in EP 620 605 A2. However, this also allows entire outlet areas to be covered, see for example JP 57-208 065 AA. All of these methods have the common feature that thorough mixing is achieved by electrolyte circulation caused by the gas that is introduced. The disadvantage of these methods is that, in consequence, additional mechanical complexity is involved, and the use of air pumps (compressors) and flexible air tubes results in an additional fault source, as well. Furthermore, appropriate vent openings are required, through which the gas that is blown in can escape again. These openings represent potential leak points in the batteries. The escaping air flow additionally takes moisture from the battery, especially at relatively high temperatures, thus increasing the water consumption of the battery.
Use of electrolyte pumps

Using appropriate tube systems, electrolyte is pumped out (sucked out) of areas where the acid density is relatively high, and is introduced back into the cell in areas with a relatively low acid density, see for example US 20040067410 A1. The process can also be reversed. The common functional principle on which this is based is to produce a flow profile by production of artificial movement of the electrolyte, preferably associated therewith, by arranging the inlet and outlet openings at a certain physical distance. Once again, the additional mechanical complexity and the susceptibility to faults can also be regarded as disadvantages of this method.
Use of internal mechanical stirring elements

It is also known for mechanical stirring elements to be used in the interior of the battery, which also lead to the electrolyte being stirred thoroughly and thus circulating, see for example JP 63-055852 M. In addition to the additional mechanical complexity for installation of the stirring element, this method has the disadvantage that a unit such as this is susceptible to faults.
Use of other internal apparatuses for thorough mixing of the electrolyte

Furthermore, mechanical apparatuses can be provided in batteries in order to form a flow profile, with the fundamental movement energy being taken from an external movement (for example movement during use in mobile applications, vehicles). However, since the natural movement in the case of batteries is, as is known, rather low, in general in mobile applications, such internal additional devices also provide only very minor assistance to the formation of specific flow profiles.
Use of external mechanical apparatuses for thorough mixing of the electrolyte

In principle, better thorough mixing of the electrolyte can also be achieved by apparatuses for production of external movement of the battery (for example shaking or tilting). However, the complexity to provide an appropriate device is difficult to implement, in particular in the field of mobile applications (predominantly motor vehicles).

This electrolyte movement group also includes thorough mixing resulting from natural driving movements when the battery is used in mobile applications.

In summary, it can be stated that, in the case of all the methods according to the prior art, either the mechanical complexity is relatively high and the mechanism results in additional susceptibility to faults, or the usefulness of the method is correspondingly low.

The object of the present invention is now to vary the state of charge of a rechargeable battery, preferably to improve it or to keep it high, and furthermore to cancel out any electrolyte stratification that occurs or to reduce the occurrence of such stratification from the start, and therefore at least to reduce all the known disadvantages in conjunction with low states of charge and electrolyte stratification.

According to the invention, this object is achieved in that at least one cell in the multicell rechargeable battery individually has a separate electric current applied to it, with this current being superimposed on a working current of the rechargeable battery, and with this current acting on this at least one cell in order to charge or discharge this cell. In the case of the arrangement according to the invention, this is achieved in that a separate electrical connection is provided on at least one cell in the multicell rechargeable battery and is passed out of the rechargeable battery, via which the current superimposed on the working current can be applied.

The invention can be used to specifically influence the state of charge of a single cell and thus, in consequence, also the state of charge of the entire rechargeable battery, for example by increasing it or decreasing it, and electrolyte stratification in the rechargeable batteries can be decreased or reduced, or can even be entirely avoided, without having to accept the disadvantages of the known methods as described above for dissipation of electrolyte stratification in rechargeable batteries. This means that the performance of the rechargeable battery without stratification of the acid is recovered, thus making it possible to avoid secondary damage resulting from low states of charge and acid stratification. Overall, therefore, the reliability of the rechargeable battery is increased, and the product life cycle can be lengthened.

In comparison to the methods according to the prior art, the method according to the invention accordingly has the major advantage of varying one or more defined cell or cells such that a state of charge which differs from that of the other cells is achieved, thus increasing the state of charge of the rechargeable battery and making it possible to dissipate electrolyte stratification efficiently and without the occurrence of interactions with the power supply system in which the rechargeable battery is being operated. This is particularly important when the provision of adequate charge (charging above the gassing voltage over a time period which is sufficiently long for thorough mixing) for the entire battery cannot be provided at all, or can be provided only with great difficulty, in the area of application of the battery (use at the place of application).

In this case, furthermore, the method an be carried out independently of a working current (load or charging current), in that the current to be applied is simply superimposed on the working current of the rechargeable battery.

It is particularly advantageous for the cells in the multicell rechargeable battery to be subdivided into at least two subunits, each comprising at least one cell, with at least one subunit having an electric current applied to it in order to charge or discharge the cell or cells contained therein. This makes it possible to ensure that the rechargeable battery is subdivided, and a current is applied to it, as appropriate to its respective purpose. The same principle can in this case also be applied to a rechargeable battery which is formed from a combination circuit comprising a plurality of individual rechargeable battery elements connected in series or in parallel.

The electrolyte stratification in the rechargeable battery is dissipated by generation of circulation of the electrolyte, by applying an electric current which leads to gassing in the cell or cells to at least one cell or to the cells in one subunit.

Depending on the application, it may be advantageous to apply a current to all the cells or all the subunits, to apply different electric currents to different cells or subunits, to apply the different electric currents in different directions, at least in some cases, and/or to apply a current alternately to the cells or subunits. Depending on the application, the applied electric currents may likewise be in the form of direct currents, alternating currents or mixed currents.

At least during a certain time period, the method according to the invention can also be used when no external power supply is available, by drawing the energy for production of the current to be applied or of the currents to be applied from the rechargeable battery. The current which is required to provide this energy is then in this case the working current. Alternatively or in addition to this, the energy can also be supplied via an external voltage supply.

The presence of additional electrical connections for a cell or subunit can easily be used to carry out monitoring of the battery state (SOC, SOH) and/or energy management of these cells or subunits.

The dissipation of electrolyte stratification can be assisted by mechanically moving the rechargeable battery while an electric current is being applied to a cell or a subunit, or by subjecting it to additional mechanical electrolyte circulation.

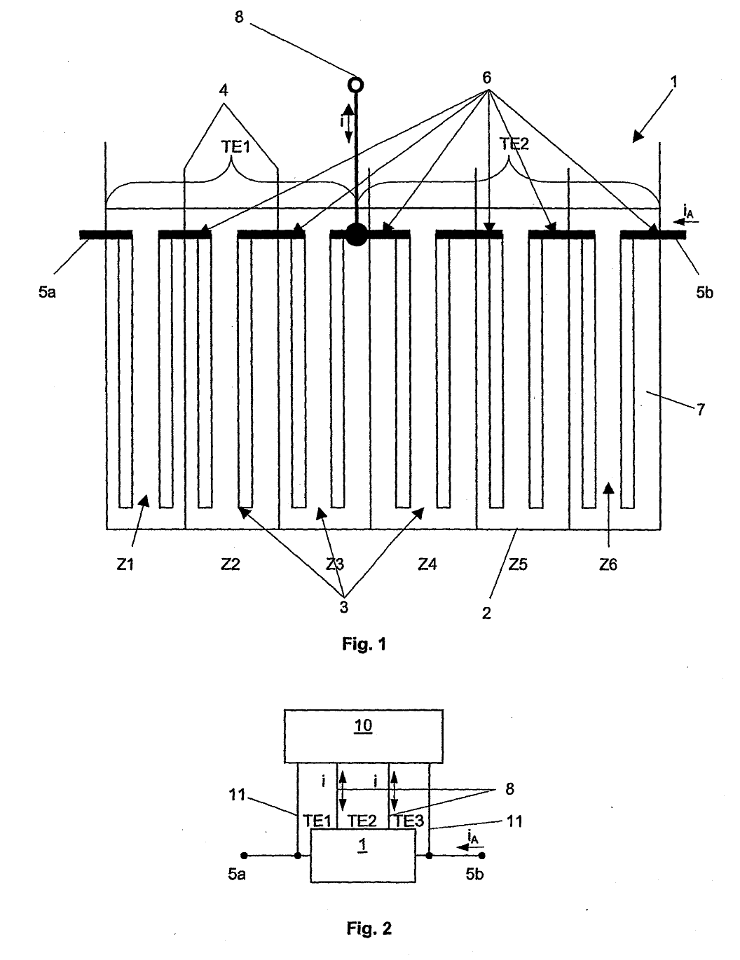

The invention will be described in the following text with reference to the schematic, exemplary and non-restrictive FIGS. 1 and 2, in which:

FIG. 1 shows a rechargeable battery with the cells subdivided according to the invention, grouped into two subunits, and

FIG. 2 shows a block diagram of an arrangement according to the invention for improving the state of charge of a battery.

FIG. 1 shows a rechargeable battery 1 subdivided according to the invention into electrical subunits TE1, TE2. The rechargeable battery, or the battery, 1 in this case comprises, as has been known for a long time, a battery box 2 which is subdivided by cell partition walls 4 into a plurality of cells, in this case six cells Z1-Z6. Each cell Z1-Z6 contains a plate set 3, for example lead plates, with the plate sets 3 being electrically connected to one another by means of cell connectors 6. The battery box 2 is in this case filled with an electrolyte 7, for example dilute sulphuric acid, which surrounds the plates in the plate sets 3. Two poles 5a and 5b are passed out of the battery box 2 as electrical connections. A working current i_{A} flows through the rechargeable battery 1, that is to say either a current which is drawn from the rechargeable battery 1 by a load, or which is fed into the rechargeable battery 1 during charging. A design such as this of a battery 1 has been known for a long time, and this will therefore not be described in any more detail here.

The totality of the rechargeable battery 1, within the meaning of the existing cells Z1-Zn, is now subdivided into electrical subunits TE1-TEn. The maximum possible number of electrical subdivisions corresponds to the number of cells in the rechargeable battery 1; one subunit TE therefore comprises at least one cell Z. For example, a 12 V starter battery can be subdivided, corresponding to the existing number of six individual cells Z1-Z6, into a maximum of six electrical subunits TE1-TE6. The minimum number of subdivisions is one, as in the present example shown in FIG. 1, in which the battery 1 is subdivided once, in consequence forming two subunits TE1, TE2, each of which has three cells Z1-Z3 and Z4-Z6.

Each subdivided electrical subunit TE1, TE2 in the rechargeable battery 1 is provided at the cell connector 6, which connects the subunits TE1 and TE2, with a separate electrical connection 8 which is passed out of the rechargeable battery 1 and allows a separate electric current i to be applied to the respective electrical subunit TE1, TE2 and to the respective cell or cells Z in a subunit TE1, TE2. This current i is in this case superimposed on the working current i_{A}. The primary connecting elements of the rechargeable battery, such as the cell connector 6 and poles 5a, 5b, do not need to be modified in terms of their arrangement and function in this case, although, of course, this would be equally possible.

Individual electrical subunits TE1, TE2 which are defined for this purpose can have an electric current i applied to them by means of an appropriate electrical current or voltage source. The current i may in this case be a direct current, alternating current or mixed current. Electrochemical processes are therefore caused in the defined subunits TE1 and/or TE2 to which the current i is applied, which electrochemical processes take place exclusively in this defined subunit TE1 and/or TE2 and do not significantly influence or change the subunits to which the current is not applied, at the time when the current is applied to the defined subunits TE1 and/or TE2. In this case, the current can be applied in various ways, specifically:
such that only one electrical subunit TE1 or TE2 is defined, which is provided with a current flow i,
such that all the electrical subunits TE1, TE2 are defined and are provided with a current flow i,
such that defined electrical subunits TE1, TE2 have individual, different current flows i applied to them. When the defined electrical subunits TE1, TE2 are different, in principle the directions of the currents i may also differ from one another, that is to say for example, one cell Z1 may be being charged while another cell Z6 is being discharged at the same time,
such that defined electrical subunits TE1, TE2 have a current i applied to them alternately,
such that only one or more (all) of the subunits TE1, TE2 is or are used for measurement purposes, that is to say no current flow i is applied to them temporarily or permanently, or
such that the current flow i (irrespective of the flow direction) is superimposed on a working current, which is applied by an external device (load or charging source) through one or more defined cell or cells Z1-Z6, and enhances or decreases its effect.

The aim of the method described above is to cause different states of charge in one or more defined cell(s) Z1-Z6 in relation to the other cells in the rechargeable battery 1, as a result of current flows i (charging or discharging) being applied, that is to say to cause a singular reaction in subunits TE1, TE2 or individual cells. It is therefore possible to charge, to overcharge or else to discharge individual cells Z or groups of cells (subunits TE1, TE2) independently of the electrochemical state of the overall rechargeable battery 1.

However, the electrical connections 8 can also be used just to provide observation (monitoring) of the subunits TE1, TE2 or of the individual cells Z1-Z6 (for example for voltage monitoring), the results of which are directly related to the singular reaction of subunits TE1, TE2 or individual cells Z1-Z6 (for example determination of the state of charge, state of charge profile, charging or discharging profile, etc.). Furthermore, the method according to the invention also offers the capability to make use of evaluations from the charging and discharging currents and the recorded voltages in the form of energy management at the level of (one) individual defined cell or cells or subunit (single cell management).

If the described method is used to bring one or more defined cells (depending on the subdivision of the battery into subunits TE1, TE2) into the region of the gassing voltage or into voltage ranges above this over wide areas of the cell surface, then, in comparison to the remaining cells—this results in more or less major gassing of this or these defined cell or cells. In particular, this results in the capability to produce a gassing reaction which leads to thorough mixing of the acid and thus to dissipation of the acid stratification. The high state of charge which can be achieved in this way in the defined cell or cells at the same time also results in a high degree of the discharge product lead sulphate (PbSO₄) being passed back from any lead-sulphate layers which may exist on the plates, and the method according to the invention is equally suitable for this purpose.

The method described above can also be applied in the same sense to applications in which a plurality of interconnected batteries are used (connected in series and/or in parallel). It is often not permissible to operate the overall voltage of the installation—in particular permanently—above a specific limit. However, it is in fact possible to operate (a) single defined cell or cells or (a) individual battery or batteries (all the cells in these batteries are then defined cells) at higher voltages (alternately and/or permanently).

In this case, it is helpful either to know the information about the state (voltage level, state of charge SOC) of the individual defined cell or cells or—with knowledge of the fundamental behaviour of the respective rechargeable battery—to generate a procedure program for controlling the application of current to (one) individual cell or cells, and to provide the battery with this.

An arrangement for carrying out the method described above is illustrated by way of example in FIG. 2. The arrangement illustrated here has a battery 1 which is subdivided by two separate electrical connections 8 into three subunits TE1, TE2, TE3, each comprising at least one cell. Furthermore, a control unit 10 is provided, and is connected to the electrical connections 8 and, via pole connections 11, to the two poles 5a, 5b of the battery 1 as well. By appropriate electrical circuitry, the control unit 10 can thus apply a current i separately or (partially) combined to each subunit TE1, TE2, TE3, with an appropriate current or voltage source being provided for this purpose in the control unit 10. This current i can be produced using an external mains-powered (for example a 230 V supply system) voltage supply 9 as well as a voltage supply 9 linked to the vehicle power supply system (for example an alternator in the motor vehicle), or internally by the rechargeable battery 1 itself.

When an external voltage supply or a voltage supply linked to the vehicle power supply system is available, this can preferably be used to produce the current flows i into the defined cell or cells or subunits TE1, TE2, TE3 in order to carry out the method according to the invention to improve the state of charge and state of health (current and voltage source).

However, the method according to the invention can also be used at times or permanently without the presence of an external, mains-powered voltage supply, or voltage supply linked to the vehicle power supply system. Use for mobile applications is of particular importance in this case. This relates primarily to all fields of use of rechargeable batteries in the field of starter batteries and vehicle power supply system batteries for motor vehicle or other vehicles, or else to applications where asymmetric loads occur, either because of the configuration of the vehicle power supply system or because of different ageing of the batteries being used (in practice the standard situation).

One possible way to produce the current flow according to the invention to influence (an) individual cell or cells, in systems without an external voltage supply, is to produce those currents i (charging or discharging currents) which are required for application to the defined cell or cells Z or subunit or subunits TE from the existing voltage (vehicle power supply system voltage, operating voltage in an electrical vehicle, etc.) by means of a suitable voltage converter circuit, for example a DC voltage converter circuit with or without an internal or external AC voltage intermediate circuit, circuits for voltage multiplication or voltage division.

It is likewise possible to use resonant circuits, in which the defined cell or cells Z or subunit or subunits TE is or are included, to produce the current flow according to the invention to influence (an) individual cell or cells, with or without an external voltage supply. By way of example, the operation of resonant circuits such as these may comprise the production of superposition effects (increases, decreases) in the defined cell or cells Z or the subunit or subunits TE which then in consequence result in secondary effects as well in these functional units they are applied to (in addition to the primary charging or discharging), such as the avoidance of undesirable electromechanical processes or in order to achieve desired electrochemical processes (deposition or dissolving processes, interactions between chemical substances in the rechargeable battery) or to bring about thermal processes (heating).

A 12 V starter battery for motor vehicles may be quoted as one specific example of an implementation of the method according to the invention. The voltage division circuit may be provided, for example, by a DC/DC converter whose input voltage side is supplied from the vehicle power supply system. On the output side, the converter produces the currents and voltages required for manipulation on one or more defined cells or subunits. The opposite procedure, specifically the drawing of energy from one or more defined cell or cells or subunit or subunits (discharging) and this energy being fed into the vehicle power supply system, is also possible.

One particular advantage of this method, irrespective of whether it is carried out with or without an external supply 9, is that this provides a technical capability to supply one or more defined cell or cells in a battery 1 with voltages and current flows i such that gassing occurs in it or them and can be exploited in order to sustainably dissipate stratification of the electrolyte 7. This makes it possible to avoid, a priori, all the consequences of stratification of the electrolyte 7. Interactions with the vehicle or the vehicle power supply system occur only when the no-load voltage plus an arbitrary voltage shift on an individual cell or a plurality of cells rises above the vehicle power supply system voltage (regulator voltage) as may occur, for example with severely discharged batteries and/or when the vehicle is operated in the undercharging mode (the vehicle power supply system generator cannot provide the total power consumption for all the loads), or else in the event of defect in the generator system. However, the only consequence in one of these situations is just the state that—when carrying out charging processes on one or more individual defined cell or cells—a current flow in the direction of charging the defined cell or cells or subunit or subunits can be achieved only after compensation for the total discharge current which is drawn from the battery (discharge current) to the full extent by the control unit 10. However, in this situation, there is no negative influence on the vehicle power supply system. It is expedient to cease operation of the control unit 10 below a specific voltage limit, although this does not represent any restriction to the method according to the invention, or to the arrangement for carrying it out.

There is equally no restriction to the method according to the invention or the arrangement for carrying it out when the supply of the control unit 10 is itself exclusively taken from the energy in the rechargeable battery 1 in order to produce the current flows i. However, from the practical point of view, there is a tendency for this variant to be of secondary importance.

1. Method for varying the state of charge and state of health (SOC, SOH) of multicell rechargeable batteries (1), whereas one cell (Z) in the multicell rechargeable battery (1) has a separate electric current (i) applied to it, with this current (i) being superimposed on a working current (i_{A}) of the rechargeable battery, and with this current (i) acting on this one cell (Z) in order to charge this cell (Z), characterized in that, the cell (Z) has an electric current (i) applied to it which leads to gassing of the cell (Z).

2. Method according to claim 1, characterized in that the cells (Z) in the multicell rechargeable battery (1) are subdivided into at least two subunits (TE1, TE2), each comprising at least one cell (Z), and at least one subunit (TE1, TE2) has an electric current (i) applied to it in order to charge or discharge the cell or cells (Z) contained therein.

3. Method according to claim 1, characterized in that the rechargeable battery (1) is formed from a combination circuit comprising a plurality of individual rechargeable battery elements connected in series or in parallel, and the cells (Z) in the rechargeable battery (1) are subdivided into at least two subunits (TE1, TE2), each comprising at least one cell (Z) of the rechargeable battery, and at least one subunit (TE 1, TE2) has an electric current (i) applied to it in order to charge or discharge the cell or cells (Z) contained therein.

4. Method according to claim 3, characterized in that a plurality of rechargeable battery elements are subdivided into at least two subunits (TE1, TE2) comprising at least one cell (Z), and at least one subunit (TE1, TE2) has an electric current (i) applied to it in order to charge or discharge the cell or cells (Z) contained therein.

5. Method according to claim 2, characterized in that the cell or cells in at least one subunit (TE1, TE2) has or have an electric current (i) applied thereto which leads to gassing of the cell or cells (Z).

6. Method according to claim 1, characterized in that all the cells (Z) or all the subunits (TE) have a current (i) applied to them.

7. Method according to claim 1, characterized in that different cells (Z) or subunits (TE) have different electric currents (i) applied to them.

8. Method according to claim 7, characterized in that at least some of the different electric currents (i) are applied in different directions.

9. Method according to claim 1, characterized in that at least two cells (Z) or at least two subunits (TE) have a current (i) applied to them alternately.

10. Method according to claim 1, characterized in that the electric currents (i) which are applied comprise direct, alternating or mixed currents.

11. Method according to claim 1, characterized in that the energy to produce the current (i) that is intended to be applied or the currents that are intended to be applied is taken from the rechargeable battery (1).

12. Method according to claim 1, characterized in that, at least at times, the energy to produce the current (i) that is intended to flow or the currents that are intended to flow is supplied via an external voltage supply.

13. Method according to claim 1, characterized in that the current (i) which is intended to be applied or the currents which are intended to be applied are produced in a resonant circuit arrangement.

14. Method according to claim 1, characterized in that, in addition to an electric current (i) being applied into individual cells (Z) or subunits (TE), the battery state (SOC, SOH) is monitored, and/or energy management is carried out for these cells or subunits.

15. Method according to claim 1, characterized in that the rechargeable battery (1) is mechanically moved while an electric current (i) is being applied to a cell (Z) or a subunit (TE).

16. Method according to claim 1, characterized in that the rechargeable battery (1) is subjected to additional electrolyte circulation, which is caused mechanically or electromagnetically, while an electric current (i) is being applied to a cell (Z) or a subunit (TE).

17. Arrangement for carrying out a method for varying the state of charge and state of health (SOC, SOH) of multicell rechargeable batteries (1), characterized in that a separate electrical connection (8) is provided on at least one cell (Z) in the multicell rechargeable battery (1) and is passed out of the rechargeable battery (1), and via which a separate electric current (i), which is superimposed on a working current (i_{A}), can be applied to the cell (Z), and this current (i) acts on this at least one cell (Z) in order to charge this cell (Z) for causing gassing of the cell (Z).

18. Arrangement according to claim 17, characterized in that the multicell rechargeable battery is subdivided into at least two subunits, each comprising at least one cell of the rechargeable battery, and a separate electrical connection is provided on one of these subunits, and is passed out of the rechargeable battery, and via which a separate electric current can be applied to the subunit for charging or discharging of the subunit.

19. Arrangement according to claim 17, characterized in that a plurality of individual rechargeable battery elements are connected in series or in parallel with a rechargeable battery, and the rechargeable battery is subdivided into at least two subunits, each comprising at least one cell of the rechargeable battery, and a separate electrical connection is provided on one of these subunits and is passed out of the rechargeable battery, and via which a separate electric current can be applied to the subunit for charging or discharging of the subunit.

20. Arrangement according to claim 19, characterized in that a plurality of rechargeable battery elements are subdivided into at least two subunits, comprising at least one cell, and a separate electrical connection is provided on one of these subunits and is passed out of the rechargeable battery, and via which a separate electric current can be applied to the subunit for charging or discharging of the subunit.

21. Arrangement according to claim 17, characterized in that a separate electrical connection is provided on each cell or each subunit and is passed out of the rechargeable battery, and via which a separate electric current can be applied to each individual cell or each individual subunit for charging or discharging of the subunit.

22. Arrangement according to claim 17, characterized in that a resonant circuit is provided in which the cell or cells, or subunit or subunits to which an electric current is to be applied is or are included.

23. Arrangement according to claim 17, characterized in that a control unit is provided in order to produce the electric current to be applied, and is connected to the separate electrical connection or to the separate electrical connections.

24. Arrangement according to claim 23, characterized in that the control unit is connected to the two poles of the rechargeable battery.

25. Arrangement according to claim 23, characterized in that the control unit takes the energy to produce the electric current to be applied or the electric currents to be applied from the rechargeable battery.

26. Arrangement according to claim 23, characterized in that a connection for an external voltage supply is provided on the control unit.

27. Arrangement according to claim 17 characterized in that a monitoring unit and/or an energy management unit is provided.

28. Arrangement according to claim 17, characterized in that a device is provided for mechanical movement of the rechargeable battery (1) while an electric current (i) is being applied to a cell (Z) or to a subunit (TE).

29. Arrangement according to claim 17, characterized in that a circulation device is provided in the rechargeable battery or in a rechargeable battery element, for mechanical or electromagnetically produced electrolyte circulation while an electric current (i) is being applied to a cell (Z) or to a subunit (TE).
